(19) United States
(12) Patent Application Publication
(10) Pub. No.: US 2004/0151806 A1
(43) Pub. Date: Aug. 5, 2004

(54) Soups and pasta dishes

(75) Inventors: Michael Charles Budd, Brighton, TN (US); David James William Gray, Wayne, NJ (US); Patricia Mary Feerick, Paramus, NJ (US)

Correspondence Address: UNILEVER, PATENT DEPARTMENT, 45 RIVER ROAD, EDGEWATER, NJ, 07020, US

(73) Assignee: Slim-Fast Foods Company

(21) Appl. No.: 10/357,139

(22) Filed: Feb. 3, 2003

(51) Int. Cl. A23L 1/30

(52) U.S. Cl. 426/72

(57) ABSTRACT

Dry soup and pasta dish mixes having a combination of ingredients which permit the formulator to continue to provide good organoleptic properties while at the same time reducing the caloric impact for those consumers who desire to limit their caloric intake. The soup and pasta mixes preferably include 250 or fewer calories, especially 245 or fewer calories, most preferably 225, 220 or fewer calories. Preferably the product includes agglomerated protein and is fortified with vitamins and minerals.

### BACKGROUND OF THE INVENTION

Increasingly, a focus of modern preventive medicine is weight reduction. Excessive weight is frequently cited in reports concerning the surge in cases of type 2 diabetes. Moreover, obesity is often cited in discussions of other modern diseases, such as heart disease.

In spite of the relentless attention in the health community to the problems caused by excess weight, weight control remains an elusive goal for many. Exercise continues to have limited appeal for a substantial proportion of the population. So, for many, diet remains the main weapon in the battle to cast off pounds.

Substantial effort has been expended in the development of foods which are conducive to weight loss and healthful. In order to make such foods palatable, they have often been sweet. Recently, much attention has been focused upon those who advocate lowering carbohydrate intake for weight loss and other health benefits. While the presence of sugar and other carbohydrates does not necessarily make a food unhealthful, in view of the consumer perception that lower carbohydrate intake is desirable, it would be useful to include in the diet arsenal palatable foods which are healthful, but not sweet.

Formulators of frozen confections and related products, as well as academics and others, have attempted to provide products having fewer calories, lower levels of fat, and various other features desired by consumers for one reason or another.

Kamarei U.S. Pat. No. 6,093,425 (Princeton Nutrition) is directed to complete nutritional milk compositions such as ice creams which are prepared through pasteurization, ultrapasteurization or sterilization processes. From about 0.1% to about 250% of the daily value of Vitamin C and from about 0.1% to about 80% of the daily values of calcium, iron, vitamin D, vitamin E, vitamin K, thiamine, riboflavin, niacin, vitamin B6, Folate, vitamin B12, biotin, pantothenic acid, iodine, magnesium, zinc, selenium, copper, phosphorus, manganese, chromium, molybdenum and chloride based on a 2000 calorie diet may be used. Fat free milk, low fat milk, full fat milk, lactose-free milk, concentrated milk and dry milk are mentioned among possible milk sources. Ice creams with 10% fat, 15% fat and 17% fat are mentioned. Sundaes and milk shakes are also said to be contemplated. Numerous protein sources such as whey protein and gelatin are given. Carbohydrate sources listed include sucrose, corn syrup solids, glucose, fructose and maltodextrin. Fiber sources such as guar gum, pectin and gum arabic are mentioned. From 10 to 25% of the daily value of essential vitamins and essential minerals are said to be used in the compositions of Table 5. Components such as fillers, flavors and emulsifiers may be included. Example 3A, Table 18 discloses a “complete nutritional light vanilla ice cream,” including full fat milk and Half & Half brand beverage lightener. Example 3B/Table 19 discloses a fat free, lactose free “complete nutritional chocolate fudgesicle ice cream” including 100% fat-free, lactose free milk. Vanilla extract is used in examples 18 and 19; example 19 employs chocolate pudding. Kamarei U.S. Pat. No. 6,030,650 is similar. Kamarei U.S. Pat. No. 5,985,339 is also related.

According to the English language abstract, Rothwell, Ice Cream and Frozen Confectionery, 1985, 36 (9) 442, 450-451 discusses the historical development of diabetic and dietetic ice creams. Use of polydextrose as bulking agent is discussed. One of the basic mixes includes 4% fat (either milk or non-milk fat), 15% polydextrose, 0.5% microcrystalline cellulose, 0.2% sodium citrate, 11.3% milk SNF, 0.75% stabilizer/emulsifier, and 0.75% aspartame.

Gabby et al. U.S. Pat. No. 3,800,036 (Drackett), is directed to frozen desserts including ice milk and imitation ice cream having optionally up to 7 wt. % fat. Polyglycerol fatty acid ester is employed as texturizing agent. Low fat or concentrated skim milk may be used. A hydrophilic colloid or gum may be used as stabilizer. Examples include locust bean gum, gelatin, carrageenan, water dispersible polysaccharides such as carboxymethyl cellulose and pectin, and starch (preferably pregelatinized). Sugar may be included and an inert bodying material such as dextran, inulin or microcrystalline cellulose may be substituted for sugar when artificial sweeteners are used. Other possible ingredients are fructose, dried egg white and starch. Milk solids may be replaced by another protein ingredient such as sodium caseinate, potassium caseinate and calcium caseinate. Liquid mixes may be frozen with aeration. Various frozen confection formulations are provided. Examples 3 (frozen dessert, shake type), 4 (fat free imitation vanilla ice cream), 5 (vanilla soft serve imitation ice cream) and 10 (chocolate imitation hard type ice cream) include ascorbic acid, niacinamide, calcium pantothenate, thiamine hydrochloride, pyridoxine hydrochloride, and riboflavin. Example 10 further includes Vitamin A & D powder. Polysorbate 80 is used in several formulations.

Berry, “From Showcased Ingredients to the Dairy Case,” Dairy Foods September 2002, mentions tricalcium phosphate among tasteless calcium salts. The article also mentions Luke's Ice Cream of Riviera Beach, Fla. as manufacturing Sugar Free Fat Free Frozen Treat made using delactosed non fat milk, polydextrose, maltodextrin, and sucralose. It also indicates that for many “better for you frozen desserts,” bulking agents such as polydextrose and maltodextrin are necessary. It has a neutral taste, is highly soluble and has fiber properties.

Coutant et al. U.S. Pat. No. 5,292,544 (reassigned to Rhodia) is directed to low fat, very low fat or fat free emulsion simulating food products prepared by adding tricalcium phosphate to develop an opaqueness and smoothness in the food, and to reduce gloppiness in foods containing gum, especially xanthan. Use in ice cream and ice milk products is mentioned. Locust bean gums, starches, starch maltodextrin and cellulose gels are mentioned. Example 8 is directed to a fat free shake including tricalcium phosphate, corn syrup solids and xanthan gum.

Toonen U.S. Pat. No. 5,456,936 is directed to a substantially lactose- and sugar-free, low calorie frozen confection having a 20% to 100% overrun. Gums which can be used are said to include locust bean gum, carrageenan, xanthan gum, guar and carboxymethyl cellulose. Cellulose gel can be used as a stabilizer. Among the bulking agents mentioned are polydextrose, maltodextrose, sugar alcohol or starches.

Proctor U.S. Pat. No. 4,251,550 is directed to a dry nutritious food composition adapted for mixing with water to form an aqueous dispersion having a pleasing palatable taste with improved filling characteristics which is useful as a total meal replacement. The aqueous dispersion can be a smooth, palatable beverage.

Bailey et al. U.S. Pat. No. 5,997,915 is directed to compositions for human consumption for supplying a reduced form of folate.

Kamarei U.S. Pat. No. 5,985,39 is directed to refrigeration shelf stable ready to drink complete nutritional products.

Bangs et al. U.S. Pat. No. 6,039,978 discloses a dietary food enhancement agent for fortifying food products. The agent includes a premixed combination of vitamins and minerals. The food products are selected from a group including soups and starch sources. A nutritionally enhanced vegetable soup is disclosed in Example 7. Nutritional information for lunch meals selected from the group of split pea soup, chicken noodle soup and pasta meals is given in Table XXII.

Ritchey et al. U.S. Pat. No. 5,688,547 is directed to a dry nutritional meal replacement composition.

Despite the appearance of a plethora of “healthy” variants of numerous types of products, it seems clear that many consumers are not willing to sacrifice the organoleptic properties of their favorite food because of some imaginable health benefit in the future. Thus, a developer of healthful foods faces the formidable challenge of providing products which continue to have outstanding organoleptic properties while at the same time reducing the caloric impact for those consumers who would benefit from assistance in losing weight.

### SUMMARY OF THE INVENTION

The present invention is directed to the discovery of soup and pasta dishes which are formulated for good organoleptic properties yet which have levels of calories and of sodium and other nutrients which make them suitable for use by individuals seeking to lose (manage) weight. The products preferably include proteins in agglomerated form. This permits use of ingredients having high levels of the protein (e.g., sodium caseinate) to be present without causing dissolution problems. The product is formulated to include combinations of ingredients which permit the manufacturer to continue to provide outstanding organoleptic properties while at the same time reducing the caloric impact for those consumers who desire to limit their caloric intake.

Preferably the soups and pastas are prepared as dry mixes, to which water can be added by consumers.

The soups and pasta dishes of the invention preferably are limited to a maximum of 250 calories per serving. Typically, serving sizes for the soups will be 10 ounces and for the pasta will be one cup. Because it is has been thought that some individuals do not tolerate high levels of sodium well, total sodium levels (from all sources in the pasta or soup product) are preferably limited to 900 mg or less per product. Various herbs, spices, and flavorings are used to enhance the flavor of the soup or pasta product.

In an especially preferred embodiment the soup or pasta product is fortified with one or more vitamins and/or minerals and/or fibers, thus further improving the health profile of the product.

The soup and pasta mixes preferably include 250 or fewer calories, especially 245 or fewer calories, most preferably 225, 220 or fewer calories

For a more complete of the above and other features and advantages of the invention, reference should be made to the following description of the preferred embodiment.

### DETAILED DESCRIPTION OF THE INVENTION

The product of the invention is a dry mix soup or a dry mix pasta dish. In either case, the dry mix will be combined with cold water by the consumer to produce a final soup or pasta product. The preferred serving sizes of 10 ounce for the soup and one cup for the pasta dish include the water which the consumer must add to make the final product.

In accordance with one aspect of the invention, the soup or pasta dish is relatively high in total protein. The protein levels are preferably at least 7 grams per serving, more preferably at least 10 grams per serving.

Suitable proteins for the products of the invention may include a dairy protein source, such as whole milk, skim milk, condensed milk, evaporated milk, whey, milk solids non-fat, etc. The dairy source may contribute dairy fat and/or non-fat milk solids such as lactose and milk proteins, e.g. whey proteins and caseins. Especially preferred, to minimize the caloric impact, is the addition of protein as such rather than as one component of a food ingredient such as whole milk. Preferred in this respect are protein concentrates such as whey protein concentrate, milk protein concentrate, caseinates such as sodium and/or calcium caseinate, isolated soy protein, soy protein concentrate.

In many instances, it will be necessary to use one or more caseinates, e.g., sodium and/or calcium caseinate, to achieve the desired protein levels and the needed organoleptic properties for acceptance of the product. In such cases, it may be desirable that some or all of the protein, especially the caseinate be agglomerated to enhance organoleptic properties, particularly to ensure dissolution of the protein and avoid sandiness or grittiness. Preferably from 5 to 50 wt % of protein in the product is agglomerated caseinate. Agglomerated particles can be purchased or, alternatively, agglomeration can be effected as known in the art, e.g., with a fluidized bed.

The level of triglyceride fat in the product, indeed preferably the total level of digestible lipid in the product, is preferably 10 wt. % or less, more preferably, 8% or less, especially 5 wt. % or less, or even 3 wt. % or less. Lower limits for the triglyceride fat or other lipids can be zero (triglyceride fat-free), 0.25 wt. % 1 wt. % or higher.

Potential fat sources include, vegetable shortening powder, butter fat from cream and other dairy sources, other vegetable fats, for example, cocoa butter, illipe, shea, palm, palm kernal, sal, soybean, cottonseed, coconut, rapeseed, canola, and sunflower oils, and animal fat such as chicken fat, lard, etc.

Among fiber sources which may be included in the compositions of the invention are fructose oligosaccharides such as inulin, gum arabic, gum acacia, and cellulose. The compositions preferably contain at least 2 grams of fiber per serving, especially at least 5 grams of fiber per serving. Additional bulking agents may be used including maltodextrin, sugar alcohols, corn syrup solids, sugars or starches. Total bulking agent levels in the products of the invention will preferably be from about 0% to 20%.

Calcium is preferably present in the composition at from 10 to 30% RDA, especially about 25% RDA. The calcium source is preferably dicalcium phosphate. For example wt. % levels of dicalcium phosphate may range from 0.5 to 1.5%. In a preferred embodiment, the product is fortified with one or more vitamins and/or minerals and/or fiber sources, in addition to the calcium source. These may include any or all of the following:

Ascorbic acid (Vitamin C), Tocopheryl Acetate (Vitamin E), Biotin (Vitamin H), Vitamin A Palmitate, Niacinamide (Vitamin B3), Potassium Iodide, d-Calcium Pantothenate (Vitamin B5), Cyanocobalamin (Vitamin B12), Riboflavin (Vitamin B2), Thiamine Mononitrate (Vitamin B1), Molybdenum, Chromium, Selenium, Calcium Carbonate, Calcium Lactate, Manganese (as Manganese Sulfate), Magnesium (e.g., as magnesium phosphate) Iron (as Ferric Orthophosphate) and Zinc (as Zinc Oxide). The vitamins are preferably present at from 5 to 20% RDI, especially from about 15% RDI. Preferably, fiber sources are present in the product at greater than 0.5 wt. % and do not exceed 6 wt. %, especially 5 wt. %

Gum stabilizers are effective in controlling viscosity and providing mouth feel; to provide a protective colloid to stabilize proteins to heat processing; to modify the surface chemistry of fat surfaces to minimize creaming; to provide acid stability to protein systems and; to increase freeze-thaw stability. Gums can be classified as neutral and acidic, straight- and branched-chain, gelling and non-gelling. The principal gums which may be used, where appropriate, are Karaya gums, locust bean gum, guar gum, carageenan, xanthan, and carboxymethyl cellulose.

Gums are generally used for stabilization and thickening in concentrations of 0.02-0.5 wt. % of the composition or 1-6 wt. % of the protein level. Because of differing functionalities, combinations of certain gums may provide a better product than a single gum.

Certain salts such as phosphates and chlorides may be employed to alter the buffering capacity of the system and to improve the water binding capacity of proteins and improve solubility and flavor. Sodium chloride and sodium monophosphate at very low levels are preferred but calcium phosphate and particularly monocalcium phosphate may also be employed. Sodium chloride may be used at levels of 0.05% to 0.3%; and sodium monophosphate may be used at levels of 0.01% to 0.1%. The bulking agents employed should have only trace amounts of mono- and disaccharides. Disodium phosphate may also be employed in the compositions of the invention.

Generally the compositions of the invention will include modest amounts, if any, of sugars such as sucrose (liquid or solids), glucose, fructose, and corn syrup (liquid or solids), especially for flavor. Other sweeteners include lactose, maltose, and galactose. Levels of sugars and sugar sources preferably result in sugar solids levels of up to 20 wt. %, preferably from 0.5 to 5 wt %, especially from 1 to 5 wt %.

If it is desired to use artificial sweeteners for flavor, any of the artificial sweeteners well known in the art may be used, such as aspartame, saccharine, Alitame® (obtainable from Pfizer), acesulfame K (obtainable from Hoechst), cyclamates, neotame, sucralose and the like. Aspartame is preferred. The sweeteners are used in varying amounts of about 0.005% to 1%, preferably 0.007% to 0.73% depending on the sweetener, for example. Aspartame may be used at a level of 0.05% to 0.15%, preferably at a level of 0.07% to 0.11%. Acesulfame K is preferred at a level of 0.09% to 0.15%.

Flavorings may be added to the product as needed to impart a desirable flavor. The flavoring may be any of the commercial flavors employed in soups or pasta dishes. It will further be appreciated that many flavor variations may be obtained by combinations of the basic flavors. Examples of suitable flavors include butter flavors, Suitable flavorants may also include seasoning, such as salt at a level of, e.g. from 0.01 to 5 wt %. Salt may be used if desired, but preferably level of sodium does not exceed 900 mg. Other seasonings may include pepper, thyme, rosemary, sage, paprika, annatto, basil, beet root, nutmeg, yeast extract, MSG, hydrolyzed protein, e.g., hyrolyzed plant protein, inosinate and guanalyate salts, tumeric, e.g., as a colorant, Colorants such as titanium dioxide and red 40 aluminum lake powder may be helpful. Croutons may be included, if desired. Flavorings which mask off-tastes from vitamins and/or minerals and other ingredients are preferably included in the products of the invention.

The product is made by dry mixing the ingredients, as is known in the art. All seasoning is added to a ribbon blender (powder mixer). Mixing takes between 12 and 15 minutes depending upon the number of ingredients and size of the batch in the mixer. The mix is placed into a large tote that is taken to the packaging line.

The mix is volumetrically filled into a soup cup or a pasta cup or pouch. Additional ingredients would be filled separately, i.e. pasta, croutons, and broccoli pieces.

The process to dry mix the material is very straightforward and well known to those of ordinary skill in the art.

Seasonings and vitamins are delivered by dry mixing components together in the ribbon blender followed by filling into a pouch or other suitable container.

In general, the mixes for the pasta dishes (sauces) will include more (by weight) ingredients which impart body, such as starch and triglycerides.

Additional ingredients which can be used include fruits and vegetables such as dehydrated potato, broccoli, potato grits, onion powder, parsley flakes, oregano, marjoram, garlic powder, tomato, e.g., as a powder or granules, starches, such as instant starch, meat, such as chicken meat, veal or beef, cheese or cheese powder, acidulants such as lactic acid powder,

For the pasta dish, the pasta per se can be included in many forms, e.g., as spaghetti, shells, macaroni and spirals.

Unless stated otherwise or required by context, the terms “fat” and “oil” are used interchangeably herein. Unless otherwise stated or required by context, percentages are by weight.

The compositions of the following examples are prepared as above using the following ingredients:

### EXAMPLE 1

Potato Cheddar and Chive Soup

| Ingredient Name | Product % |
|---|---|
| Non fat dry milk | 41-43 |
| Dehyrated Potato | 16-17 |
| Potato starch | 8-10 |
| Gum Arabic | 8 |
| Vegetable Shortening Powder | 5 |
| Vitamin and mineral Premix | 4 |
| Cheese Powder | 4 |
| Flavoring | 3 |
| Oil | 1-2 |
| Salt | 1-2 |
| Onion Powder | 1 |
| Hyrolyzed plant protein | 0.2-0.8 |
| Seasoning/spice | 1 |
| Chives | 0.2-0.3 |
| Garlic Powder | 0.1-0.2 |
| | 100.0000 |

### EXAMPLE 2

Creamy Chicken Soup

| Ingredient Name | Product % |
|---|---|
| Whey Protein Concentrate | 25-26 |
| Non fat dry milk | 16-17 |
| Instant Starch | 12 |
| Gum Arabic | 10-11 |
| Flavor Enhancer | 5-7 |
| Vitamin & mineral Premix | 4-5 |
| Maltodextrin | 4-5 |
| Chicken Fat | 3.5 |
| Seasoning/Spice | 0.5-1 |
| Flavoring | 3-4 |
| Calcium Caseinate (Agglomerated) | 1 |
| Disodium Phosphate | 1 |
| Chicken Meat | 1 |
| Sugar | 0.5-1 |
| Onion Powder | 0.5 |
| Guar Gum | 0.2 |
| Garlic Powder | 0.2 |
| Color | 0.03 |
| Croutons | 8-9 |
| | 100.0000 |

### EXAMPLE 3

Cream of Tomato Soup

| Ingredient Name | Product % |
|---|---|
| Whey Protein Concentrate | 25 |
| Tomato Power | 16-17 |
| Non fat dry milk | 14 |
| Instant Starch | 12 |
| Gum arabic | 8-9 |
| Vitamin and mineral Premix | 4 |
| Sugar | 2-3 |
| Flavor Enhancer | 3-4 |
| Flavoring | 1-2 |
| Oil | 1-2 |
| Coloring | 1-2 |
| Agglomerated Calcium Caseinate | 1. |
| Disodium Phosphate | 1. |
| Onion Powder | 0.5 |
| Seasoning/spice | 1 |
| Garlic Powder | 0.2-0.3 |
| Gum, guar | 0.15-2 |
| Croutons | 4. |
| | 100.0000 |

### EXAMPLE 4

| Ingredient Name | Product % |
|---|---|
| Cream of Broccoli Soup | |
| Whey Protein Concentrate | 39 |
| Instant Starch | 16-17 |
| Gum Arabic | 10-11 |
| Flavoring | 6-7 |
| Agglomerated Calcium Caseinate | 5-6 |
| Vegetable Shortening Powder | 5-6 |
| Vitamin and mineral Premix | 4-5 |
| Oil | 3-4 |
| Salt | 1-2 |
| Seasoning/spice | 0.1 |
| Flavor enhancer | 3 |
| Onion Powder | 1-2 |
| Garlic powder | 0.2 |
| | 100.0000 |

### EXAMPLE 5

| Ingredient Name | Product % |
|---|---|
| Herb Tomato Pasta Dish | |
| Isolated soy protein | 5-6 |
| Tomato powder | 6-8 |
| Flavoring | 5-6 |
| Gum arabic | 4-5 |
| Sugar | 4-5 |
| Vitamin & mineral premix | 3.8 |
| Instant starch | 3. |
| oil | 1-2 |
| Corn syrup solids | 1-2 |
| Seasoning/spice | 0.5-1 |
| Salt | 0.9 |
| Onion powder | 0-1 |
| Garlic powder | 0-1 |
| Xanthan gum | 0.15 |
| Color | 0.005-.001 |
| pasta | 60-61 |
| | 100.0000 |

### EXAMPLE 6

Sundried Tomato & Parmesan

| Ingredient Name | Product % |
|---|---|
| Gum arabic | 5-6 |
| Instant starch | 3-4 |
| Vitamin & mineral premix | 3-4 |
| Romano and parmesan cheese | 4 |
| Cheese powder | 3 |
| Flavoring | 5-6 |
| Milk protein concentrate | 3. |
| Corn syrup solids | 2.8 |
| Dried tomatoes | 3 |
| Salt | 0.7 |
| Disodium phosphate | 0.35 |
| Basil | 0.17 |
| Flavor Enhancer | 1-2 |
| Xanthan gum | 0.17 |
| Spiral pasta | 58. |
| | 100.0000 |

### EXAMPLE 7

Cheddar Formula Pasta Dish

| Ingredient Name | Product % |
|---|---|
| cheese powder | 15-17 |
| Instant starch, | 6-7 |
| Gum arabic | 6. |
| Cheese powder | 15-17 |
| Vitamin & mineral premix | 3-4 |
| Calcium caseinate, agglomerated | 3. |
| Flavoring | 1 |
| Parmesan cheese | 2-3 |
| Salt | 1.8 |
| Disodium phosphate | 0.45 |
| Lactic acid powder | 0.38 |
| Xanthan gum | 0.15 |
| Color | 0.01 |
| Pasta shells | 57. |
| | 100.0000 |

### EXAMPLE 8

Alfredo sauce

| Ingredient Name | Product % |
|---|---|
| Cheese Powder | 10-12 |
| Instant Starch | 7-8 |
| Milk Protein Concentrate | 6-7 |
| Gum Arabic | 6 |
| Vitamin Premix | 3-4 |
| Agglomerated Calcium Caseinate | 3 |
| Parmesan Cheese | 3 |
| Salt | 2 |
| Flavoring | 2 |
| Disodium phosphate | 0.6 |
| Sugar | 0.6 |
| Color | 0.5 |
| Seasoning/Spice | 0.5 |
| Monosodium glutamate (MSG) | 0.38 |
| Acidulant | 0.38 |
| Xanthan gum | 0.15 |
| Macaroni | 51 |
| | 100.00 |

It should be understood of course that the specific forms of the invention herein illustrated and described are intended to be representative only, as certain changes may be made therein without departing from the clear teaching of the disclosure. Accordingly, reference should be made to the appended claims in determining the full scope.

What is claimed is:

1. A dry mix soup comprising per serving a dry mix of: at least 7 grams of protein, at least 2 grams of fiber and 250 calories or less.

2 The soup according to claim 1, at least 1 gram of said protein being agglomerated caseinate.

3. The soup according to claim 1 comprising at least 10 grams of protein per serving and at least 5 grams of fiber per serving.

4. The soup according to claim 1 further comprising per serving at least 15% of the RDA for at least ten of the following vitamins and minerals:
calcium, ascorbic acid (Vitamin C), tocopheryl Acetate (Vitamin E), Biotin, Vitamin A Palmitate, Niacinamide (Vitamin B3), Potassium Iodide, d-Calcium Pantothenate (Vitamin B5), Cyanocobalamin (Vitamin B12), Riboflavin (Vitamin B2), Thiamine Mononitrate (Vitamin B1), Molybdenum, Chromium, Selenium, magnesium, Manganese, Iron and Zinc.

5. The soup according to claim 4 wherein the level of at least ten of the following vitamins and minerals is at least 30% of the RDA:
calcium, ascorbic acid (Vitamin C), tocopheryl Acetate (Vitamin E), Biotin, Vitamin A Palmitate, Niacinamide (Vitamin B3), Potassium Iodide, d-Calcium Pantothenate (Vitamin B5), Cyanocobalamin (Vitamin B12), Riboflavin (Vitamin B2), Thiamine Mononitrate (Vitamin B1), Molybdenum, Chromium, Selenium, magnesium, Manganese, Iron and Zinc.

6. The soup according to claim 3 comprising per serving 225 calories per serving or fewer.

7. The soup according to claim 1 wherein the level of triglyceride fat is less than 10 wt. %.

8. The soup according to claim 2 wherein the level of triglyceride fat is less than 5 wt. %.

9. The soup according to claim 1 wherein the serving size for the dry mix is 10 ounces.

10. A pasta dish comprising per serving a dry mix of: at least 7 grams of protein, at least 2 grams of fiber and 250 calories or less.

11. The pasta dish according to claim 9, wherein at least 1 gram of said protein being agglomerated caseinate.

12 The pasta dish according to claim 9 comprising at least 10 grams of protein per serving and at least 5 grams of fiber per serving.

13. The pasta dish according to claim 9 further comprising per serving at least 15% of the RDA for at least ten of the following vitamins and minerals:
calcium, ascorbic acid (Vitamin C), tocopheryl Acetate (Vitamin E), Biotin, Vitamin A Palmitate, Niacinamide (Vitamin B3), Potassium Iodide, d-Calcium Pantothenate (Vitamin B5), Cyanocobalamin (Vitamin B12), Riboflavin (Vitamin B2), Thiamine Mononitrate (Vitamin B1), Molybdenum, Chromium, Selenium, magnesium, Manganese, Iron and Zinc.

14. The pasta dish according to claim 9 wherein the level per serving of the RDA for at least ten of the following vitamins and minerals is at least 30%:
calcium, ascorbic acid (Vitamin C), tocopheryl Acetate (Vitamin E), Biotin, Vitamin A Palmitate, Niacinamide (Vitamin B3), Potassium Iodide, d-Calcium Pantothenate (Vitamin B5), Cyanocobalamin (Vitamin B12), Riboflavin (Vitamin B2), Thiamine Mononitrate (Vitamin B1), Molybdenum, Chromium, Selenium, magnesium, Manganese, Iron and Zinc.

15. The pasta dish according to claim 9 comprising per serving 240 calories per serving or fewer.

16. The pasta dish according to claim 9 wherein the level of triglyceride fat is less than 10 wt. %.

17. The pasta dish according to claim 14 wherein the level of triglyceride fat is less than 5 wt. %.

18. The dry pasta dish mix according to claim 1 wherein the serving size for the dry mix is 10 ounces.
